(19) United States
(12) Patent Application Publication
(10) Pub. No.: US 2026/0138568 A1
(43) Pub. Date: May 21, 2026

(54) PUMP AND SENSOR CLEANING DEVICE INCLUDING THE SAME

(71) Applicants: Hyundai Motor Company, Seoul (KR); Kia Corporation, Seoul (KR); Hyundam Industrial Co., Ltd., Asan-si (KR)

(72) Inventors: Seung Hyun LEE, Hwaseong-si (KR); Sang Hyuk HA, Hwaseong-si (KR); Hyun Jin KANG, Cheonan-si (KR); II Kyu CHOI, Cheonan-Si (KR); Jong Beom LEE, Cheonan (KR)

(73) Assignees: Hyundai Motor Company, Seoul (KR); Kia Corporation, Seoul (KR); Hyundam Industrial Co., Ltd., Asan-si (KR)

(21) Appl. No.: 19/236,090

(22) Filed: Jun. 12, 2025

(30) Foreign Application Priority Data
Nov. 20, 2024 (KR) 10-2024-0165778

(51) Int. Cl. B60S 1/56; B60S 1/54; F04B 43/02; F04B 53/00

(52) U.S. Cl. CPC B60S 1/56; B60S 1/54; F04B 43/02; F04B 53/001

(57) ABSTRACT

A pump may include a housing including a first chamber and a second chamber therein, a first diaphragm defining the first chamber together with the housing and configured to increase a volume of the first chamber by taking in a fluid and to decrease the volume of the first chamber by discharging the fluid, and a second diaphragm defining the second chamber together with the housing and configured to increase a volume of the second chamber by taking in a fluid and to decrease the volume of the second chamber by discharging the fluid, wherein the first chamber and the second chamber may be simultaneously increased or decreased in volume.

### CROSS-REFERENCE TO RELATED APPLICATION

The present application claims priority to Korean Patent Application No. 10-2024-0165778, filed on Nov. 20, 2024, the entire contents of which is incorporated herein for all purposes by this reference.

### BACKGROUND OF THE PRESENT DISCLOSURE

### Field of the Present Disclosure

The present disclosure relates to a pump.

### Description of Related Art

A pump is a device that moves fluid. For example, a diaphragm pump, a type of positive displacement pump, is configured to transfer fluid by repeating the contraction and expansion strokes of the diaphragm by driving of a motor.

The diaphragm pump may be operated in an air-distribution manner for spraying oil, etc., or in a motor-driving manner suitable for a small pump.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a pump that can reduce noise or vibration.

Another object of the present disclosure is to provide a pump that can supply a fluid to clean a sensor of a vehicle and a sensor cleaning device including the same.

Yet another object of the present disclosure is to provide a pump that can clean a sensor of a vehicle in a simple manner when needed to improve the marketability of the vehicle and a sensor cleaning device including the same.

The object of the present disclosure is not limited to the foregoing, and other objects not mentioned herein will be clearly understood by one including ordinary skill in the art to which the present disclosure pertains based on the description below.

The features of the present disclosure to achieve the object of the present disclosure as described above and to perform the characteristic functions of the present disclosure to be described later are as follows.

According to one form of the present disclosure, a pump may include a housing including a first chamber and a second chamber therein, a first diaphragm defining the first chamber together with the housing and configured to increase a volume of the first chamber by taking in a fluid and to decrease a volume of the first chamber by discharging the fluid, and a second diaphragm defining the second chamber together with the housing and configured to increase a volume of the second chamber by taking in a fluid and to decrease a volume of the second chamber by discharging the fluid. Here, the first chamber and the second chamber may be simultaneously increased or decreased in volume.

According to another form of the present disclosure, a sensor cleaning device includes a pump, a passage, and a nozzle. The pump may include a housing including a first chamber and a second chamber therein, a first diaphragm defining the first chamber together with the housing and configured to increase a volume of the first chamber by taking in a fluid and to decrease a volume of the first chamber by discharging the fluid, and a second diaphragm defining the second chamber together with the housing and configured to increase a volume of the second chamber by taking in a fluid and to decrease a volume of the second chamber by discharging the fluid, wherein the first chamber and the second chamber may be simultaneously increased or decreased in volume. The passage is configured to allow fluids discharged from the first chamber and the second chamber to be mixed and moved. The nozzle may be configured to be fluidly connected with the passage and to spray the mixed fluid.

Other aspects and exemplary embodiments of the present disclosure are discussed infra.

It is to be understood that the term “vehicle” or “vehicular” or other similar terms as used herein are inclusive of motor vehicles in general, such as passenger automobiles including sports utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a cross-sectional view of a pump according to an exemplary embodiment of the present disclosure;

FIG. 1A is an enlarged view of the portion indicated by a dotted line in FIG. 1;

FIG. 2 is an exploded perspective view of a pump according to an exemplary embodiment of the present disclosure;

FIG. 3 illustrates an intake operation of a pump according to an exemplary embodiment of the present disclosure;

FIG. 4 illustrates a discharge operation of a pump according to an exemplary embodiment of the present disclosure;

FIG. 5 is a perspective view of a pump according to an exemplary embodiment of the present disclosure;

FIG. 6 illustrates an exemplary sensor cleaning device in which a pump according to an exemplary embodiment of the present disclosure is applied; and

FIG. 7 is a schematic view of a vehicle.

It should be understood that the appended drawings are not necessarily to scale, presenting a somewhat simplified representation of various exemplary features illustrative of the basic principles of the present disclosure. The specific design features of the present disclosure, including, for example, specific dimensions, orientations, locations, and shapes, will be determined in part by the intended application and usage environment.

In the figures, the reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Descriptions of specific structures or functions presented in the exemplary embodiments of the present disclosure are merely exemplary for explaining the embodiments according to the concept of the present disclosure, and the embodiments according to the concept of the present disclosure may be implemented in various forms. Furthermore, the descriptions should not be construed as being limited to the embodiments described herein, and should be understood to include all modifications, equivalents and substitutes falling within the idea and scope of the present disclosure.

Meanwhile, in an exemplary embodiment of the present disclosure, terms such as “first” and/or “second” may be used to describe various components, but the components are not limited by the terms. These terms are only used to distinguish one component from another. For example, a first component could be termed a second component, and similarly, a second component could be termed a first component, without departing from the scope of exemplary embodiments of the present disclosure.

It will be understood that, when a component is referred to as being “connected to” or “brought into contact with” another component, the component may be directly connected to or brought into contact with the other component, or intervening components may also be present. In contrast, when a component is referred to as being “directly connected to” or “brought into direct contact with” another component, there is no intervening component present. Other terms used to describe relationships between components should be interpreted in a like fashion (e.g., “between” versus “directly between,” “adjacent” versus “directly adjacent,” etc.).

Throughout the specification, like reference numerals indicate like components. The terminology used herein is for illustrating embodiments and is not intended to limit the present disclosure. In the present specification, the singular form includes the plural sense, unless specified otherwise. The terms “includes” and/or “including” used in the present specification mean that the cited component, step, operation, and/or element does not exclude the presence or addition of one or more of other components, steps, operations, and/or elements.

Hereinafter, the present disclosure is described in detail with reference to the accompanying drawings.

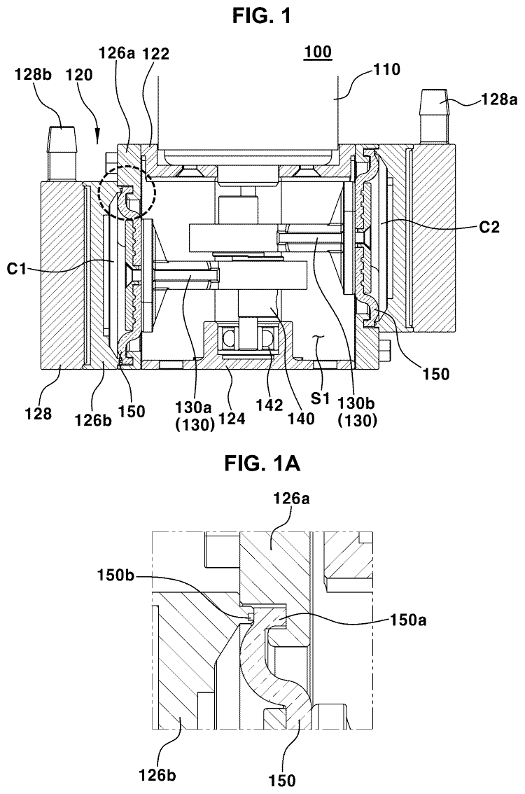

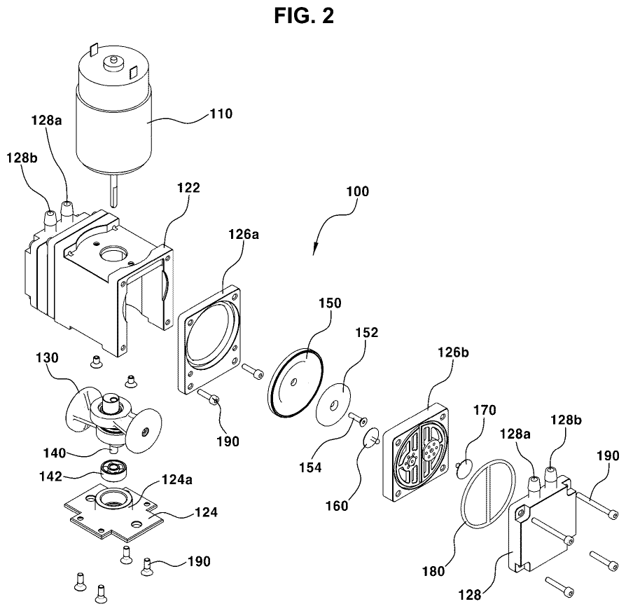

As illustrated in FIG. 1 to FIG. 2, a pump 100 is configured to move a fluid. The fluid pressurized by the pump 100 may be sprayed or supplied to a target. According to one implementation, the fluid may be air. The pump 100 may be driven by a motor 110.

The pump 100 includes a housing 120. The motor 110 may be operatively coupled to the housing 120. In an exemplary embodiment of the present disclosure, the motor 110 may be an electric motor. As a non-limiting example, the motor 110 may be a direct-current motor. The motor 110 is configured to rotate when power is supplied.

A space S1 is disposed within the housing 120. According to one implementation, the space S1 may be defined by an upper cover 122, a lower cover 124, and a side internal cover 126a of the housing 120, and a diaphragm 150. In an exemplary embodiment of the present disclosure, the upper cover 122, the lower cover 124 and the side internal cover 126a may be integrated. In another implementation, at least some of the upper cover 122, the lower cover 124, or the side internal cover 126a may be detachably fastened to each other using one or more bolts 190. A driving portion of the pump 100 may be provided in the space S1, and the space S1 may be separated from chambers C1 and C2.

The motor 110 is configured to drive the pump 100. The rotational power of the motor 110 may be transferred to the pump 100 through a shaft of the motor 110. A piston arm 130 may be mounted to the shaft of the motor 110. In an exemplary embodiment of the present disclosure, two piston arms 130 may be mounted to the shaft of the motor 110. The two piston arms 130 are configured to simultaneously perform an intake stroke or a discharge stroke.

The shaft of the motor 110 is eccentrically positioned with respect to the piston arms 130. In an exemplary embodiment of the present disclosure, a joint 140 may be mounted to the shaft of the motor 110. The joint 140 may eccentrically couple each of the piston arms 130 to the shaft of the motor 110 to convert the rotation motion of the motor 110 into the stroke motion of the piston arm 130. The joint 140 may include two portions that are eccentric with respect to the axial direction of the joint 140. The piston arms 130 may be disposed to extend opposite each other.

The joint 140 may be rotatably supported by the housing 120. In an exemplary embodiment of the present disclosure, the lower cover 124 of the housing 120 is provided with a receiving portion 124a. A bearing 142 may be mounted in the receiving portion 124a. An end portion of the joint 140 may be rotatably supported in the housing 120 through the bearing 142 in the receiving portion 124a. As a non-limiting example, the bearing 142 may be a ball bearing.

The diaphragm 150 may be mounted on the piston arm 130. For example, the diaphragm 150 may be mounted to the piston arm 130 using a cap 152 and a fixation member 154. The diaphragm 150 is configured to intake or discharge a fluid by change in volume. As a non-limiting example, the diaphragm 150 may be made of rubber, thermoplastic elastomer, or polytetrafluoroethylene (PTFE).

As illustrated in FIG. 1A, the diaphragm 150 and the housing 120 may define an airtight first and second chambers C1, C2 between the diaphragm 150 and the housing 120. In an exemplary embodiment of the present disclosure, a middle cover 126b may be mounted to an external side of the side internal cover 126a. A first portion 150a on the rim portion of the diaphragm 150 may be fixed to the side internal cover 126a, and a second portion 150b on the rim portion of the diaphragm 150 may be fixed to the middle cover 126b. The first portion 150a and the second portion 150b may extend in opposite directions, allowing the diaphragm 150 and the middle cover 126b to define the airtight first and second chambers C1, C2 there between. The side internal cover 126a and the middle cover 126b are configured to generate a pressure by the diaphragm 150. According to an exemplary embodiment of the present disclosure, the chambers C1 and C2 do not need to maintain pressure balance, so a pressure balance tube may be omitted, which may reduce costs owing to the omission of components.

The middle cover 126b may be provided with a pair of valves 160 and 170. In an exemplary embodiment of the present disclosure, an intake valve 160 and a discharge valve 170 may be disposed on opposite surfaces of the middle cover 126b, respectively. Each valve 160, 170 may be selectively opened and closed. In an exemplary embodiment of the present disclosure, the valves 160 and 170 include the intake valve 160 and the discharge valve 170. The intake valve 160 may be opened when a fluid flows in from the outside of the first and second chambers C1, C2, and the discharge valve 170 may be opened when a fluid is discharged from the inside of the first and second chambers C1, C2.

The intake valve 160 may be fluidly connected to an intake port 128a configured to allow a fluid to flow in from of the outside of the first and second chambers C1, C2. The discharge valve 170 may be fluidly connected to a discharge port 128b configured to allow a fluid to flow out from the inside of the first and second chambers C1, C2. The intake port 128a and the discharge port 128b may be formed on the housing 120. For example, the intake port 128a and the discharge port 128b may be formed on an external cover 128.

The external cover 128 may be coupled to an external side of the middle cover 126b. As a non-limiting example, the external cover 128 may be coupled to the middle cover 126b using the one or more bolts 190.

In an exemplary embodiment of the present disclosure, a seal 180 may be mounted between the middle cover 126b and the external cover 128. The seal 180 may perform a sealing function so that the fluid flows only through the intake port 128a or the discharge port 128b through the valves 160 and 170 during the intake or discharge operation of the pump 100.

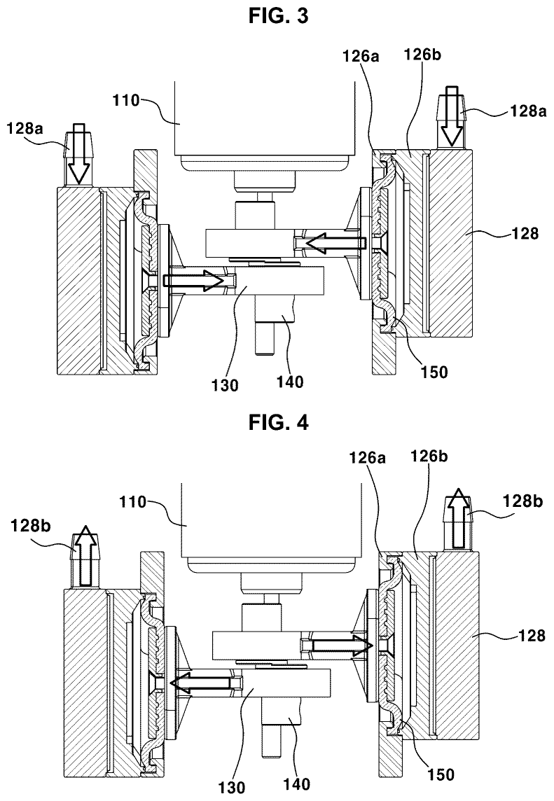

As illustrated in FIG. 3 and FIG. 4, during the intake or discharge operation of the pump 100, two piston arms 130 may simultaneously intake air from their respective chambers C1 and C2 or may simultaneously discharge air from their respective chambers C1 and C2. In an exemplary embodiment of the present disclosure, a first chamber C1 and a second chamber C2 may operate independently from each other. As in the illustrated exemplary embodiment of the present disclosure, there may be provided the chambers C1 and C2 independent from each other for their respective piston arms 130.

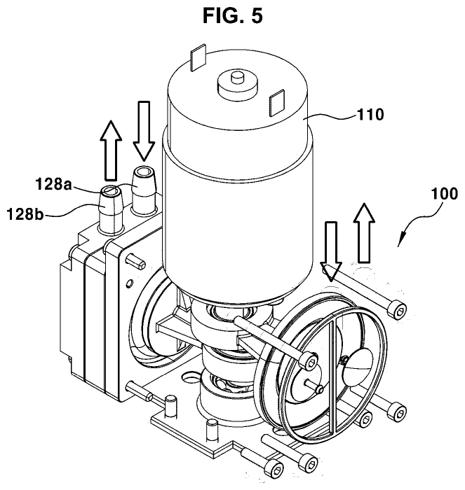

When the motor 110 rotates, the joint 140 may convert the rotation motion of the motor 110 into a translational motion. The piston arms 130 eccentrically coupled to the shaft of the motor 110 by the joint 140 may move linearly. When movements of the piston arms 130 occur, volume of each first and second chambers C1, C2 may be increased or decreased by the diaphragms 150. When the chambers C1 and C2 are increased in volume, a fluid may be taken into the chambers C1 and C2 through the intake ports 128a, as illustrated in FIG. 3. When the fluid is taken into the chambers C1 and C2, the intake valves 160 are opened and the discharge valves 170 are placed in a closed position thereof. When the chambers C1 and C2 are decreased in volume, the fluid may be discharged from the chambers C1 and C2 through the discharge ports 128b, as illustrated in FIG. 4. When the fluid is discharged from the chambers C1 and C2, the discharge valves 170 may be opened and the intake valves 160 may be placed in a closed position thereof. As illustrated in FIG. 5, the pressurized fluid discharged from each discharge port 128b may meet in one passage outside the pump 100 and be transferred to a destination through one passage.

The pump 100 according to an exemplary embodiment of the present disclosure may be applied to various fields. For example, the pump 100 may be configured to supply a fluid or air for cleaning a sensor mounted on a vehicle V.

Vehicles are provided with driver assistance systems for safe driving of drivers. Moreover, autonomous vehicles capable of travelling on their own without driver intervention have recently appeared. Vehicles provided with driver assistance systems or autonomous vehicles are provided with various sensors to recognize the surroundings of the vehicle. For example, the sensors may include a camera, LiDAR sensor, radio detection and ranging (Radar) sensor, or the like.

For a sensor to keep performing its function, the surface of the sensor must be kept clean to a certain degree or higher. For example, when foreign substances, such as water droplets, stains, or dust, are attached to the surface of a camera provided in a vehicle, it becomes difficult to secure a field of view. The pump 100 may be configured to clean such a sensor, such as a camera.

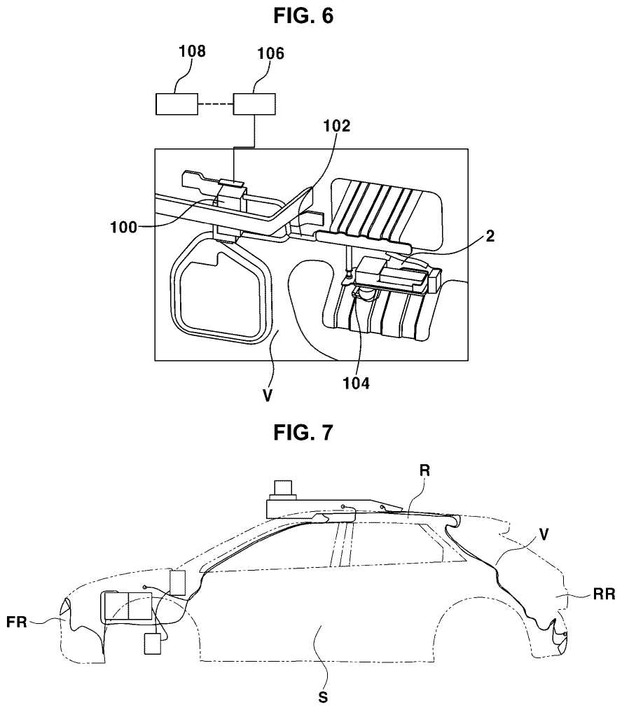

As illustrated in FIG. 6, according to some forms of the present disclosure, a sensor cleaning device may include the pump 100. As illustrated in FIG. 7, the sensor cleaning device is configured to clean one or more environment sensors 2 mounted at the front FR, rear RR, sides S, or roof R of the vehicle V. As a non-limiting example, the environment sensors 2 may include a camera, LiDAR sensor, radar sensor, or the like.

For example, when the camera 2 mounted at the rear RR of the vehicle V, e.g., at the tailgate, is contaminated during reverse parking, the driver of the vehicle V may request the pump 1 to clean the camera 2 without having to get out of the vehicle V. In an exemplary embodiment of the present disclosure, the driver's request may be transmitted to the pump 100 using an activation button 108, such as a button provided in the vehicle V or a device configured to communicate with the vehicle V by wire or wirelessly.

Upon receiving the driver's request, the pump 100 may be driven. For example, the sensor cleaning device may include a controller 106 configured to control driving of the pump 1 or a power source configured to supply power to the pump 100. In one example, the controller 106 is configured to drive the pump 100 based on a cleaning request from the driver. Air pressurized by the pump 100 may be directed to a nozzle 104 configured to be in fluidic communication with the passage 102. By driving the pump 100, air may be sprayed onto the camera 2 through the nozzle 104 provided on or around the camera 2. For example, upon a cleaning request via an activation button 108, air may be sprayed onto the camera 2 for a predetermined time period. Here, the camera 2 is merely one example, and cleaning of other types of sensors may also be possible. Moreover, the air supplied by the pump 100 may be directed to sensors located not only at the rear RR of the vehicle V, but also at the front FR, roof R, or sides S. In some implementations, the pump 100 may be automatically activated to perform cleaning of the camera 2 when a foreign substance on the sensor 2 is detected. In the present way, the sensor cleaning device of the present disclosure may smoothly secure a field of vision by cleaning the sensor in a situation, such as when parking during rain.

The sensor cleaning device including the pump according to an exemplary embodiment of the present disclosure may improve the marketability of a vehicle by enabling cleaning of sensors.

In a vehicle including a conventional sensor cleaning system, cleaning of a sensor was performed by a compressor and a tank configured to store therein a compressed fluid. On the other hand, according to an exemplary embodiment of the present disclosure, a sensor may be kept clean just by use of a pump when needed.

In addition, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory.

As is apparent from the above description, the present disclosure provides the following effects.

According to an exemplary embodiment of the present disclosure, provided is a pump that can reduce noise or vibration.

According to an exemplary embodiment of the present disclosure, provided are a pump that can supply a fluid to clean a sensor of a vehicle and a sensor cleaning device including the same.

According to an exemplary embodiment of the present disclosure, provided are a pump that can clean a sensor of a vehicle in a simple manner when needed to improve the marketability of the vehicle and a sensor cleaning device including the same.

Effects of the present disclosure are not limited to what has been described above, and other effects not mentioned herein will be clearly recognized by those skilled in the art based on the above description.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the embodiments are used for describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A pump comprising:
a housing including a first chamber and a second chamber therein;
a first diaphragm defining the first chamber with the housing and configured to expand the first chamber by taking a fluid into the first chamber and to compress the first chamber by discharging the fluid out of the first chamber; and
a second diaphragm defining the second chamber with the housing and configured to expand the second chamber by taking a fluid into the second chamber and to compress the second chamber by discharging the fluid out of the second chamber,
wherein volumes of the first chamber and the second chamber are simultaneously increased or decreased.

2. The pump of claim 1, further including a motor engaged to the first diaphragm and the second diaphragm and configured to supply the first diaphragm and the second diaphragm with a moving force.

3. The pump of claim 2, further including:
a joint coupled to a shaft of the motor and eccentrically positioned with respect to the shaft of the motor;
a first piston arm rotatably connecting the joint to the first diaphragm; and
a second piston arm rotatably connecting the joint to the second diaphragm.

4. The pump of claim 3, wherein the joint includes a portion eccentric with respect to an axial direction of the joint and configured to position the first piston arm and the second piston arm so that the volumes of the first chamber and the second chamber are simultaneously increased or decreased according to rotation of the motor.

5. The pump of claim 1,
wherein the housing includes a first middle cover defining the first chamber with the first diaphragm, and
wherein the first middle cover includes a first intake valve configured to be selectively opened to allow the fluid to flow into the first chamber and a first discharge valve configured to be selectively opened to discharge the fluid from the first chamber.

6. The pump of claim 5, including:
a first external cover coupled to the first middle cover,
wherein the first external cover includes a first intake port communicating with the first chamber through the first intake valve and a first discharge port communicating with the first chamber through the first discharge valve.

7. The pump of claim 6,
wherein the housing includes a second middle cover defining the second chamber with the second diaphragm, and
wherein the second middle cover includes a second intake valve configured to be selectively opened to allow the fluid to flow into the second chamber and a second discharge valve configured to be selectively opened to discharge the fluid from the second chamber.

8. The pump of claim 7, including:
a second external cover coupled to the second middle cover,
wherein the second external cover includes a second intake port communicating with the second chamber through the second intake valve and a second discharge port communicating with the second chamber through the second discharge valve.

9. The pump of claim 8, including:
a first seal disposed between the first external cover and the first middle cover; and
a second seal disposed between the second external cover and the second middle cover.

10. The pump of claim 1, wherein the first diaphragm and the second diaphragm are made of a contractible material.

11. The pump of claim 5,
wherein the first diaphragm includes a first portion and a second portion, and
wherein the first portion of the first diaphragm is fixed to the housing and the second portion of the first diaphragm is fixed to the first middle cover.

12. The pump of claim 7,
wherein the second diaphragm includes a first portion and a second portion, and
wherein the first portion of the second diaphragm is fixed to the housing and the second portion of the second diaphragm is fixed to the second middle cover.

13. The pump of claim 3,
wherein the housing includes a space, wherein the joint, the first piston arm, and the second piston arm are disposed in the space, and
wherein the space is separated from the first chamber and from the second chamber.

14. A sensor cleaning apparatus, the apparatus comprising:
a pump, wherein the pump includes:
a housing including a first chamber and a second chamber therein;
a first diaphragm defining the first chamber with the housing and configured to increase a volume of the first chamber by taking a fluid into the first chamber and to decrease the volume of the first chamber by discharging the fluid out of the first chamber; and
a second diaphragm defining the second chamber with the housing and configured to increase a volume of the second chamber by taking a fluid into the second chamber and to decrease the volume of the second chamber by discharging the fluid out of the second chamber,
wherein the volumes of the first chamber and the second chamber are simultaneously increased or decreased;
a passage connected to the first chamber and the second chamber and configured to allow the fluid discharged from the first chamber and the second chamber to be mixed and moved; and
a nozzle fluidically communicating with the passage and configured to spray the mixed fluid.

15. The apparatus of claim 14, wherein the nozzle is configured to spray the fluid onto a sensor configured to detect a surrounding environment from a vehicle.

16. The apparatus of claim 15, wherein the sensor includes a camera, a Light Detection and Ranging (LiDAR) sensor, or a radio detection and ranging (Radar) sensor disposed on the vehicle.

17. The apparatus of claim 15, wherein the fluid is air.

18. The apparatus of claim 15, further including:
an activation button configured to send an activation request to the pump, wherein the pump is configured to be driven based on the activation request.

19. The apparatus of claim 18, wherein the pump is configured to be driven for a predetermined time period based on the activation request.

20. A vehicle including the sensor cleaning apparatus of claim 15.
